(19) United States
(12) Patent Application Publication
(10) Pub. No.: US 2026/0024857 A1
(43) Pub. Date: Jan. 22, 2026

(54) RECHARGEABLE ENERGY STORAGE SYSTEM

(71) Applicant: GM GLOBAL TECHNOLOGY OPERATIONS LLC, Detroit, MI (US)

(72) Inventors: Alexander M. Bilinski, Avoca, MI (US); Phillip D. Hamelin, Clarkston, MI (US); Lu Huang, Troy, MI (US); Hui-Ping Wang, Troy, MI (US); Yunzhi Xu, Ferndale, MI (US)

(73) Assignee: GM GLOBAL TECHNOLOGY OPERATIONS LLC, Detroit, MI (US)

(21) Appl. No.: 18/779,527

(22) Filed: Jul. 22, 2024

(51) Int. Cl. H01M 50/233; H01M 10/613; H01M 10/625; H01M 10/6554; H01M 50/224; H01M 50/244; H01M 50/249

(52) U.S. Cl. CPC H01M 50/233; H01M 10/613; H01M 10/625; H01M 10/6554; H01M 50/224; H01M 50/244; H01M 50/249; H01M 2220/20

(57) ABSTRACT

A method of manufacturing an electrical energy storage system includes procuring a sheet metal blank. The method also includes bending the sheet metal blank to form a tray having at least a first wall, a second wall, and a bottom, with the first wall extending generally perpendicularly from the bottom and the second wall extending generally perpendicularly from the bottom. A plurality of electrical storage elements are placed in the interior of the tray. A beam may pass through an interior of the tray and may be affixed to a first structural element and a second structural element of a vehicle.

### INTRODUCTION

This disclosure is in the field of rechargeable energy storage systems.

A rechargeable energy storage system may be used to store electrical energy that is used by an electric vehicle for propulsion. A rechargeable energy storage system that is efficient to manufacture, provides high volumetric efficiency for packaging individual electrical energy storage elements, and that may provide favorable packaging in the vehicle will be advantageous.

### SUMMARY

An energy storage system for a vehicle includes an energy storage system including a tray including a sheet metal bottom, a first sheet metal side wall extending generally perpendicularly from the sheet metal bottom, and a second sheet metal side wall extending generally perpendicularly from the sheet metal bottom, the tray defining an interior of the tray and the exterior of the tray. The energy storage system additionally includes a beam passing through the interior of the tray, the beam having a first end and a second end, the first end adapted to couple to a structural element of a vehicle and the second end adapted to couple to a structural element of the vehicle. The energy storage system also includes a plurality of electrical energy storage elements disposed in the tray.

The tray may also include a third side wall affixed to the first sheet metal side wall and to the second sheet metal side wall and a fourth side wall affixed to the first sheet metal side wall and to the second sheet metal side wall. The third sheet metal side wall and the fourth sheet metal side wall may extend perpendicularly from the sheet metal bottom. Substantially continuous welds may join adjacent ones of the first sheet metal side wall, the second sheet metal side wall, the third sheet metal side wall, and the fourth sheet metal side wall. In a variation, the beam may include a flange affixed to the third side wall.

In another variation, the beam may include at least two pieces. Further, a vehicle may include the foregoing energy storage system, with the beam coupled to a first structural element of the vehicle and to a second structural element of the vehicle.

A method of manufacturing an electrical energy storage system includes procuring a sheet metal blank; creating a tray, including by bending the sheet metal blank to form a first wall of the tray, a second wall of the tray, and a bottom of the tray, the first wall extending generally perpendicularly from the bottom and the second wall extending generally perpendicularly from the bottom, wherein the tray defines an interior of the tray and an exterior of the tray; and placing a plurality of electrical storage elements in the interior of the tray. The method may include forming strengthening features in at least one of the first wall and the second wall before bending the sheet metal blank. In a variation, the method may include affixing a cooling plate to the bottom of the tray on the exterior of the tray. The cooling plate may be affixed before bending the sheet metal blank to form the first wall of the tray, the second wall of the tray, and the bottom of the tray.

The method may include procuring a third wall and a fourth wall; welding the third wall to the first wall and the second wall, with the third wall extending generally perpendicularly from the bottom of the tray; and welding the fourth wall to the first wall and the second wall, with the fourth wall extending generally perpendicularly from the bottom of the tray. Welding the third wall to the first wall may be performed using spot welding to form a joint between the first wall and the third wall. Further, sealant may be applied to seal the joint.

In a variation, the step of bending the sheet metal blank to form a tray further comprises bending the sheet metal blank to form a third wall of the tray extending generally perpendicularly from the bottom of the tray and bending the sheet metal blank to form a fourth wall of the tray extending generally perpendicularly from the bottom of the tray. Adjacent ones of the first wall, the second wall, the third wall and the fourth wall may be welded to form substantially continuous joints therebetween.

A beam may be affixed to the third wall of the tray and to the fourth wall of the tray with the beam passing through the interior of the tray. A first end of the beam may be coupled to a first structural element of a vehicle, and a second end of the beam may be coupled to a second structural element of the vehicle. The vehicle may define a vehicle longitudinal axis and a vehicle lateral axis, the first structural element of the vehicle may extend generally parallel to the vehicle lateral axis, the second structural element of the vehicle may extend generally parallel to the vehicle lateral axis, and the beam may extend generally parallel to the vehicle longitudinal axis.

A second vehicle defines a vehicle longitudinal axis and a vehicle lateral axis. The vehicle includes a first vehicle structural element and a second vehicle structural element, the first vehicle structural element and the second vehicle structural element extending generally parallel to the vehicle lateral axis. The vehicle also includes an energy storage system including: a tray defining an interior of the tray and an exterior of the tray; a beam passing through the interior of the tray and disposed generally parallel to the vehicle longitudinal axis, the beam coupled at a first end thereof to the first vehicle structural element and the beam coupled at a second end thereof to the second vehicle structural element; and a plurality of electrical energy storage elements disposed in the tray. The tray includes a sheet metal bottom, a first sheet metal side wall integral to and extending generally perpendicularly from the sheet metal bottom, a second sheet metal side wall integral to and extending generally perpendicularly from the sheet metal bottom, a third side wall affixed to the first sheet metal side wall and to the second sheet metal side wall and extending generally perpendicularly from the sheet metal bottom, and a fourth side wall affixed to the first sheet metal side wall and to the second sheet metal side wall and extending generally perpendicularly from the sheet metal bottom.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 illustrates a rechargeable energy storage system.

FIG. 2 is an exploded view of the rechargeable energy storage system of FIG. 1.

FIG. 3 illustrates details of the tray of the rechargeable energy storage system.

FIG. 4 illustrates batteries or battery cells as installed in the tray of the rechargeable energy storage system.

FIG. 5 illustrates a beam that may be installed in the tray of the rechargeable energy storage system.

FIG. 6 is a cross section of a portion of a variation of the beam.

FIG. 7 shows detail of the installation of the beam in the rechargeable energy storage system.

FIG. 8 illustrates the rechargeable energy storage system installed in a vehicle.

FIG. 9 illustrates an alternative tray for the rechargeable energy storage system.

FIG. 10 illustrates a blank that may be folded to form the tray illustrated in FIG. 9.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

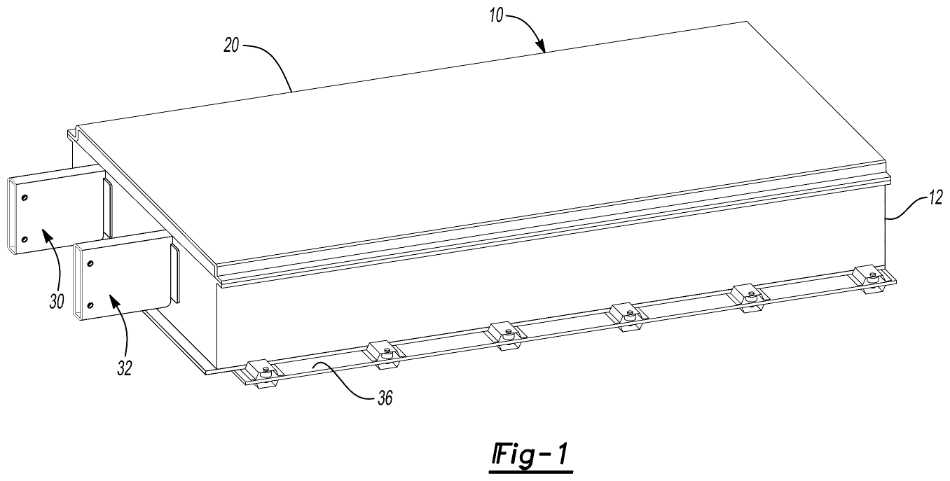

Refer first to FIG. 1, where a rechargeable energy storage system (“RESS”) 10 is illustrated. Rechargeable energy storage system 10 may be for a vehicle, such as an electrically-propelled vehicle and may include within it any number of electrical storage elements, such as batteries or battery cells.

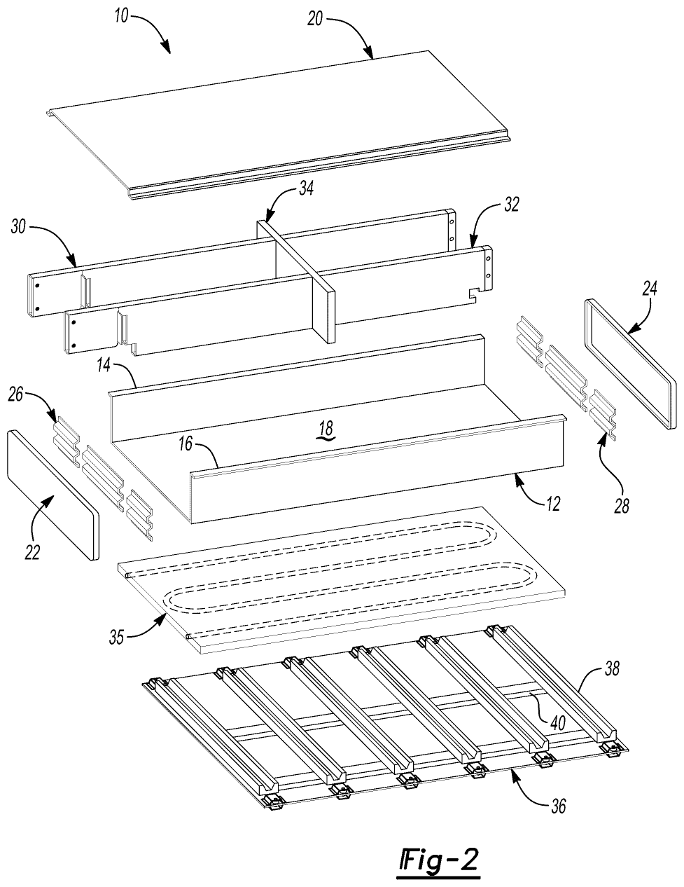

Refer additionally to FIG. 2, which shows an exploded view of RESS 10 (excluding, for clarity, the individual electrical energy storage elements packaged in RESS 10). RESS 10 may include a tray 12. Tray 12 may be composed of sheet metal, such as sheet steel, sheet aluminum, or other sheet metals in various varieties, including high-strength or advanced forms. Tray 12 may have two side walls, side wall 14 and side wall 16, bent from a common sheet metal blank with a bottom 18 of tray 12. That is, side wall 14 and side wall 16 may be said to be integral with bottom 18. Side wall 14 and side wall 16 may be bent with a press brake, rollers or other processes for bending, employing appropriate springback compensation. As so formed, side wall 14 and side wall 16 may extend perpendicularly or generally perpendicularly or substantially perpendicularly from bottom 18. Side wall 14 and side wall 16 may have very little or even zero draft. Also as so formed, side wall 14 and side wall 16 may have very small radii at the edges formed between side wall 14 and bottom 18 and between side wall 16 and bottom 18. The radii may be as small or smaller than the thickness of the sheet metal; the limit may be defined by the sheet metal's bending limit characterized by r/t, where r is the bend radius and t is the material thickness. These tight radii may provide for high volumetric efficiency when packaging electrical storage elements, such as batteries or battery cells, within tray 12.

RESS 10 may include a cover 20. Cover 20 may be formed of metal, such as sheet metal, or other suitable materials and affixed to tray 12 in a suitable manner. For instance, cover 20 may be affixed using adhesive, spot welding with sealant, or laser welding.

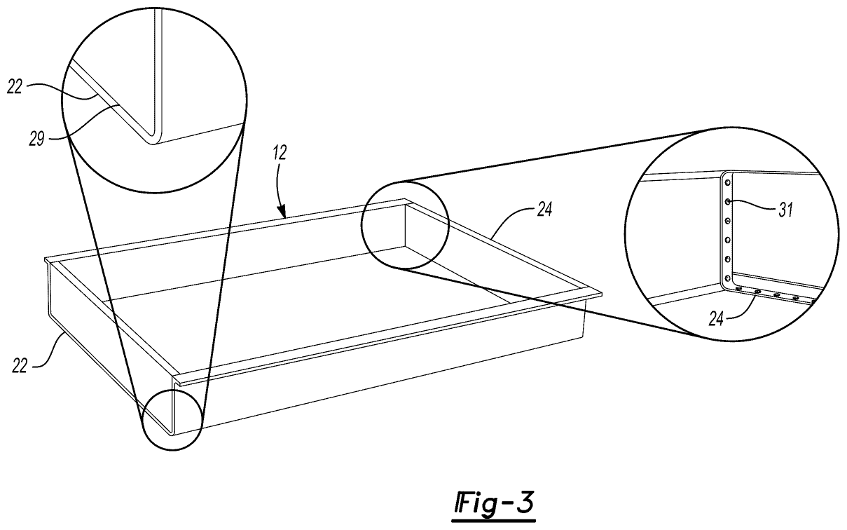

RESS 10 may also include side wall 22 and side wall 24, and the method of manufacturing RESS 10 may include procuring side wall 22 and side wall 24. Side wall 22 and side wall 24 close the respective ends of tray 12 and may extend perpendicularly, generally perpendicularly, or substantially perpendicularly from bottom 18. Side wall 22 and side wall 24 may be of a suitable metal, plastic or another suitable material. Side wall 22 and side wall 24 may be formed by molding, casting, or by another suitable method. Side wall 22 and side wall 24 may be affixed to tray 12 by continuous welding 29 (see also FIG. 3) on the exterior of tray 12 or by spot welding 31 (FIG. 3) on the interior of tray 12. Where a non-continuous weld such as spot welding 31 is used, sealant or adhesive may be used to provide a continuous or hermetic seal between the interior and the exterior of tray 12. Reinforcements, such as reinforcement 26 and reinforcement 28, may be provided to strengthen side wall 22 and side wall 24. Reinforcement 26 and reinforcement 28 may be made, for instance, of sheet metal bent to have beads or creases that act to strengthen reinforcement 26 and reinforcement 28. Reinforcement 26 and reinforcement 28 may be joined to side wall 22 and side wall 24, respectively, by spot welding or other suitable joining mechanisms.

Side wall 14, side wall 16, side wall 22, side wall 24, and bottom 18 define an interior of RESS 10 (within the walls and bottom 18) and an exterior of RESS 10 (outside the walls and bottom 18). Suitable openings in the side walls to accommodate electrical wiring between the electrical storage elements within tray 12 and the exterior of tray 12 are provided, but are not illustrated here for clarity of illustration.

RESS 10 may include a beam 30. Beam 30 may pass through the interior of tray 12 and extend from the respective ends of tray 12. Beam 30 may pass through suitably-sized openings in side wall 22 and side wall 24. Beam 30 may be a structural element intended to carry compressive loads as part of the structure of a vehicle in which RESS 10 may be installed. RESS 10 may also include a beam 32, which may be similar to beam 30 in design and function. Beam 32 may pass through suitably-sized openings in side wall 22 and side wall 24. RESS 10 may also include a reinforcing member 34, which may extend from side wall 14 to side wall 16 and couple beam 30 and beam 32. Beam 30 and beam 32 may pass through suitably-sized openings in reinforcing member 34. Reinforcing member 34 may be affixed, such as by welding, to beam 30 and beam 32 and to the insides of side wall 14 and side wall 16. Reinforcing member 34 may be made of a suitable material, such as metal.

RESS 10 may also include a liquid cooling plate 35, which may be affixed to the exterior of bottom 18. Cooling plate 35 is designed with cooling channels for flow of coolant from a cooling system of the vehicle in which RESS 10 may be installed. Cooling plate 35 may be affixed to bottom 18 by a number of bonding methods, including brazing, laser welding, and friction stir welding. Cooling plate 35 may be affixed before bending the side walls into their perpendicular, generally perpendicular or substantially perpendicular relationship with bottom 18 of tray 12. Alternatively, that affixing may be done after the side walls are bent. A significant advantage of affixing cooling plate 35 to the exterior of RESS 10 is that batteries or battery cells installed in the interior of tray 12 will not be exposed to fluid from potential leaks from cooling plate 35.

RESS 10 may be mounted to a structural foundation such as frame 36. Frame 36 may be comprised of channels 38 and bars 40 to which RESS 10 may be fastened using suitable fastening members, such as brackets 63 or clips, which may be attached to the exterior of RESS 10, such as by welding, and affixed to frame 36, such as by fasteners.

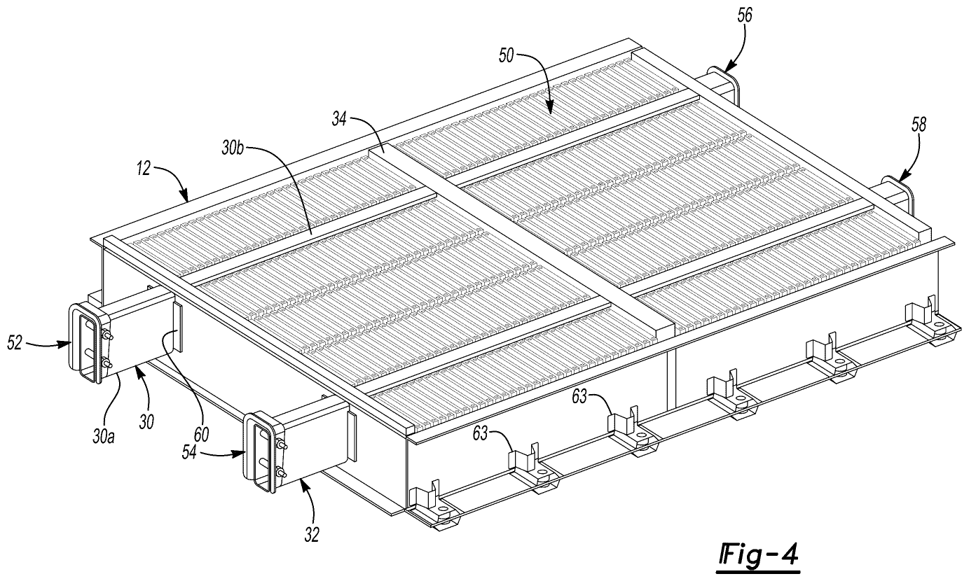

Refer additionally to FIG. 4. Illustrated there is tray 12, with cover 20 removed. Disposed within RESS 10 in tray 12 are a plurality of individual electrical storage elements 50, such as batteries or battery cells. Also illustrated there are beam 30 and beam 32. Shown affixed to beam 30 is a bracket 52, which may be affixed to beam 30 by suitable fasteners or other fastening methods. Bracket 52 may be welded or otherwise joined to a structural beam of the vehicle in which RESS 10 may be installed. Likewise, a bracket 54 may be affixed to beam 32 and welded or otherwise joined to a structural beam of the vehicle. Additionally, a bracket 56 may be affixed to a second end of beam 30 and welded or otherwise joined to a structural element, such as a structural beam, of the vehicle. Further, a bracket 58 may be affixed to a second end of beam 32 and welded or otherwise joined to a structural element, such as a structural beam, of the vehicle. In view of the above, it may be appreciated that the ends of beam 30 and beam 32 may be viewed as being adapted to couple to structural elements or structural beams of a vehicle.

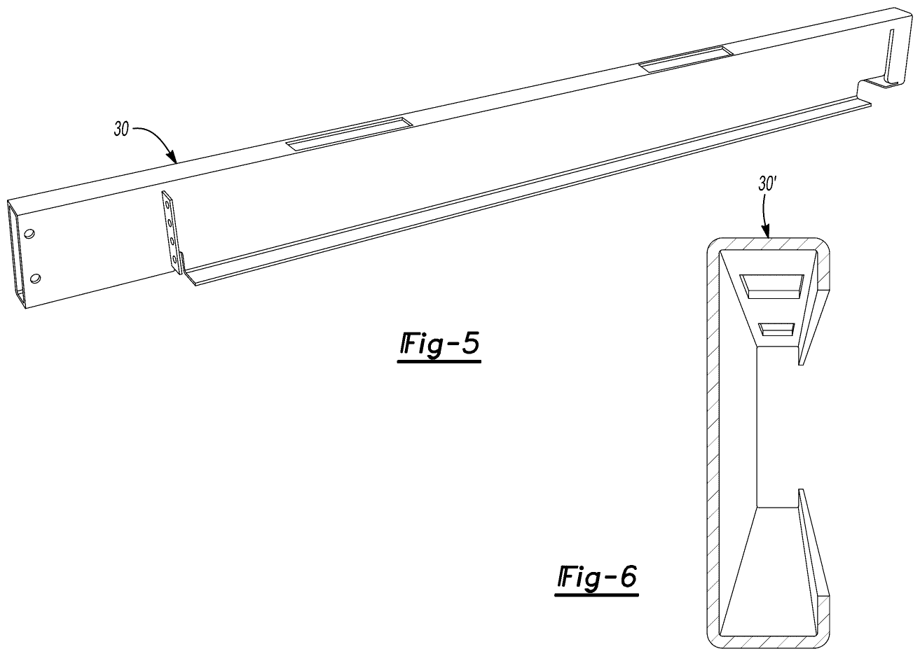

FIG. 5, FIG. 6 and FIG. 7 illustrate details of a beam, such as beam 30, and its installation in RESS 10. Beam 30 may have a closed section for all or part of its length, as visible in FIG. 7. As an alternative, a beam 30′ may have an open section for all or part of its length, as visible in the cross section of beam 30′ shown in FIG. 6; beam 30′ may otherwise be constructed similarly to beam 30. Beam 30 is designed of material and geometry to suit its function as described herein. Beam 30 may be metallic and may further be steel. Beam 30 may be a single beam that runs through side wall 22 and side wall 24 and through the interior of tray 12. Alternatively, beam 30 may be a beam assembly with two or more pieces or sections such as section 30a and 30b. The pieces or sections may be installed collinearly to collectively form beam 30 that runs through the interior of tray 12. It should be noted that for the purpose of this disclosure, a “beam” may refer either to a single-piece beam or to a beam that comprises two or more pieces or sections disposed collinearly or substantially collinearly with one another. Beam 30 may comprise three sections, one section outside each end of tray 12 and one section in the interior of tray 12.

Beam 30 may be formed with flanges that may be cut and bent outward from beam 30, such as flange 60. Flange 60 may also be a separate piece that is attached to beam 30, such as by welding. Flange 60 may be welded, such as by spot welds 64 or by continuous welding, to the exterior of side wall 22 of tray 12. Beam 30 may similarly be affixed to the exterior of side wall 24 and/or to the interior of side wall 22 and side wall 24 via additional flanges. Beam 30 and beam 32 may be affixed to side wall 22 and side wall 24 by other means than flanges. For instance, continuous welds may be used around the peripheries of the one or more of the openings in side wall 22 and side wall 24 through which beam 30 and beam 32 may pass. Beam 30 and beam 32 may be formed by bending or by roll forming.

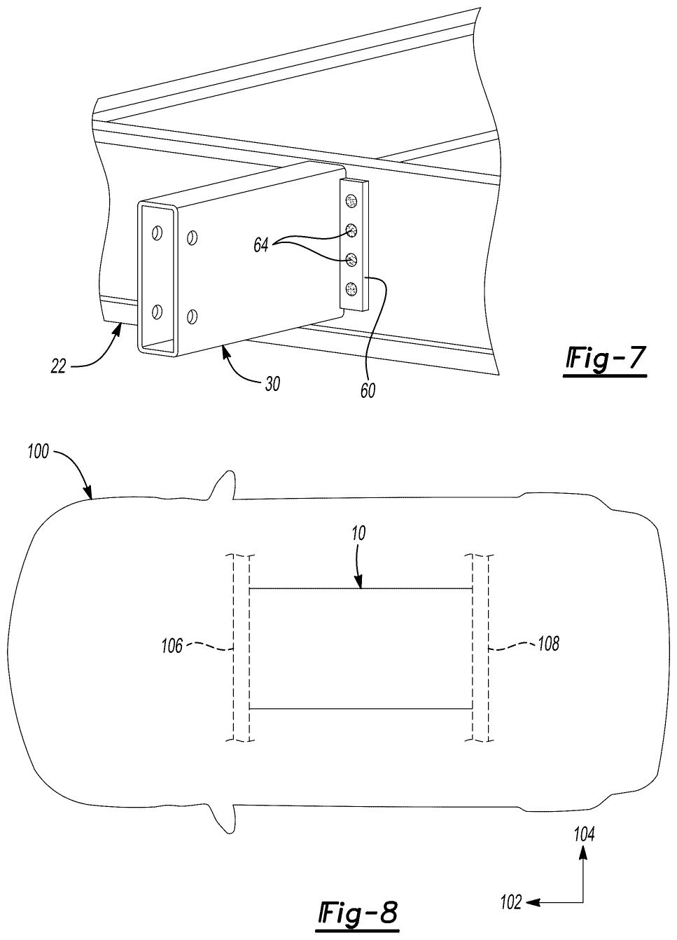

Refer additionally to FIG. 8. Illustrated there is a vehicle 100. Vehicle 100 may be any type or style of vehicle, such as a car, truck, van, sport-utility vehicle, motorcycle, bicycle, scooter, or other vehicle. Vehicle 100 may be an electric vehicle, that is, a vehicle that derives some or all of its propulsive energy from electrical energy stored in an electrical storage device such as RESS 10. Vehicle 100 may define a vehicle longitudinal axis 102 that runs fore-aft or generally fore-aft relative to vehicle 100. Vehicle 100 may also define a vehicle lateral axis 104 that runs perpendicular or generally perpendicular to longitudinal axis 102.

Vehicle 100 may have certain structural elements to provide structural integrity to vehicle 100. Those structural elements may include structural element 106 and structural element 108, each of which is shown in relevant part in FIG. 8. Structural element 106 and structural element 108 may be structural beams that run parallel to or generally parallel to vehicle lateral axis 104 and connect to additional structure of vehicle 100.

RESS 10 may be mounted between structural element 106 and structural element 108. Beam 30 and beam 32 of RESS 10 may be coupled to structural element 106 and structural element 108 by bracket 52, bracket 54, bracket 56, and bracket 58. As beam 30 and beam 32 may be designed of materials and geometry to give beam 30 and beam 32 substantial structural strength, beam 30 and beam 32 may supplement the overall structural integrity of vehicle 100.

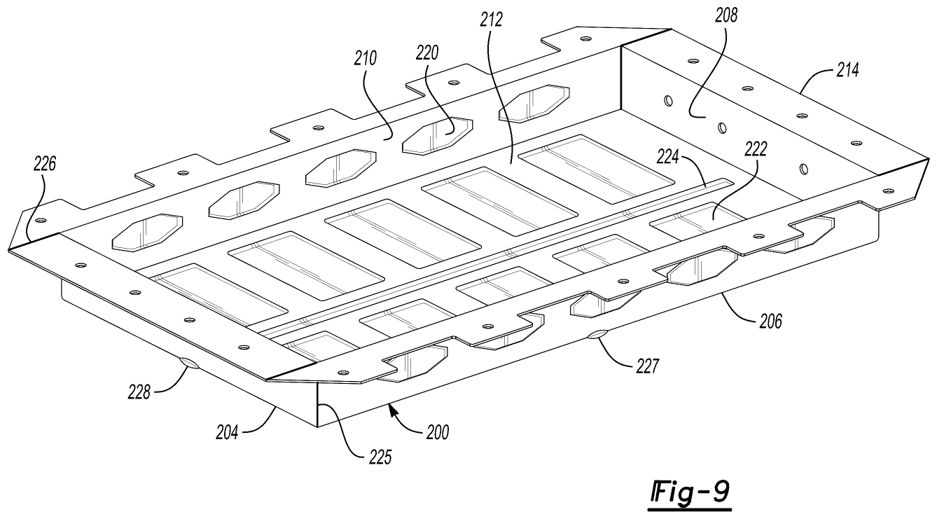

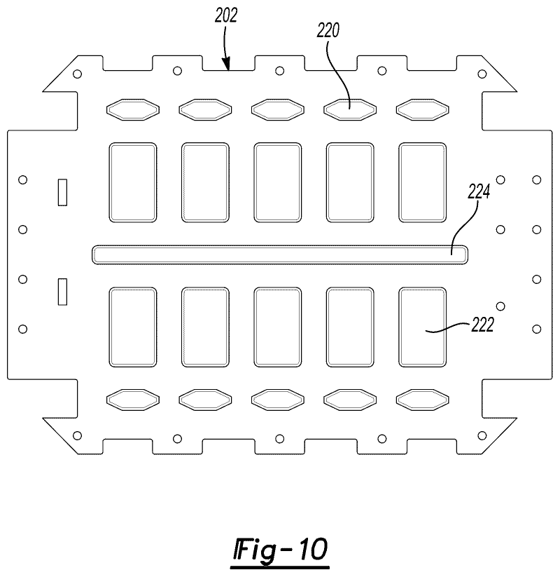

Refer now to FIG. 9 and FIG. 10. Illustrated there is a second configuration of a tray for RESS 10. Tray 200 may be formed from a blank 202, which may be sheet metal. Blank 202 may be steel, aluminum, or other metals in several varieties, including high-strength or advanced forms. Once blank 202 is procured and then is suitably formed, such as by punching, into the shape shown in FIG. 10, blank 202 may be bent into the shape of tray 200 using, for instance, a press brake. Suitable springback compensation may be used in order to cause side wall 204, side wall 206, side wall 208 and side wall 210 of tray 200 to be perpendicular or substantially perpendicular or generally perpendicular to bottom 212 of tray 200. The side walls may have very little or even zero draft. Flanges such as flange 214 may be provided for attachment of a cover to tray 200. Strengthening features such as depressions or dimples, including dimple 220, dimple 222, dimple 224 may be provided in blank 202 by stamping or other suitable processes. Darts, such as dart 227 and dart 228, may also be formed into the edges between one or more of the side walls and bottom 212 to add further strength to tray 200. The darts may extend away from the exterior of tray 200 or they may extend inward to the interior of tray 200. The side walls of tray 200 may be joined at their edges by welding, which may be continuous welding such as laser welding and which may form seams such as seam 225. As such, the adjacent ones of side wall 204, side wall 206, side wall 208, and side wall 210 are welded together. It is also apparent in this example disclosure that side wall 204, side wall 206, side wall 208, and side wall 210 are integral with bottom 212, being folded from a common blank. Further, seams in the top flange of tray 200, such as seam 226, may be formed by welding, such as by continuous welding such as laser welding.

Any number of strengthening elements, such as dart 227 and dart 228, may be formed in the edges of tray 200 for added strength. The darts may be formed in blank 202 before bending or folding into tray 200, or they may be formed in the edges of tray 200 after blank 202 is bent or folded into tray 200.

The design of RESS 10 according to this disclosure may provide many advantages. It may be efficient to manufacture, may provide high volumetric efficiency for packaging individual electrical energy storage elements, and may provide favorable packaging in a vehicle. Another benefit of the bending-enabled design of RESS 10 may be the ability to form materials of high strengths to improve structural rigidity and mass efficiency of RESS 10.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

What is claimed is:

1. An energy storage system for a vehicle, comprising:
a tray comprising a sheet metal bottom, a first sheet metal side wall extending generally perpendicularly from the sheet metal bottom, and a second sheet metal side wall extending generally perpendicularly from the sheet metal bottom, the tray defining an interior of the tray and an exterior of the tray;
a beam passing through the interior of the tray, the beam having a first end and a second end, the first end adapted to couple to a structural element of a vehicle and the second end adapted to couple to a structural element of the vehicle; and
a plurality of electrical energy storage elements disposed in the tray.

2. The energy storage system of claim 1, wherein the tray further comprises:
a third side wall affixed to the first sheet metal side wall and to the second sheet metal side wall; and
a fourth side wall affixed to the first sheet metal side wall and to the second sheet metal side wall.

3. The energy storage system of claim 1, wherein the tray further comprises a third sheet metal side wall and a fourth sheet metal side wall, the third sheet metal side wall and the fourth sheet metal side wall extending generally perpendicularly from the sheet metal bottom.

4. The energy storage system of claim 3, further comprising substantially continuous welds joining adjacent ones of the first sheet metal side wall, the second sheet metal side wall, the third sheet metal side wall, and the fourth sheet metal side wall.

5. The energy storage system of claim 2, wherein the beam comprises a flange affixed to the third side wall.

6. The energy storage system of claim 1, wherein the beam comprises at least two pieces.

7. A vehicle comprising the energy storage system of claim 1, with the beam coupled to a first structural element of the vehicle and to a second structural element of the vehicle.

8. A method of manufacturing an electrical energy storage system comprising:
procuring a sheet metal blank;
creating a tray, including by bending the sheet metal blank to form a first wall of the tray, a second wall of the tray, and a bottom of the tray, the first wall extending generally perpendicularly from the bottom and the second wall extending generally perpendicularly from the bottom, wherein the tray defines an interior of the tray and an exterior of the tray; and
placing a plurality of electrical storage elements in the interior of the tray.

9. The method of claim 8, further comprising forming strengthening features in at least one of the first wall and the second wall before bending the sheet metal blank.

10. The method of claim 8, further comprising:
procuring a third wall and a fourth wall;
welding the third wall to the first wall and the second wall, with the third wall extending generally perpendicularly from the bottom of the tray; and
welding the fourth wall to the first wall and the second wall, with the fourth wall extending generally perpendicularly from the bottom of the tray.

11. The method of claim 8, wherein the step of bending the sheet metal blank to form a tray further comprises bending the sheet metal blank to form a third wall of the tray extending generally perpendicularly from the bottom of the tray and bending the sheet metal blank to form a fourth wall of the tray extending generally perpendicularly from the bottom of the tray.

12. The method of claim 11, further comprising welding adjacent ones of the first wall, the second wall, the third wall and the fourth wall to form substantially continuous joints therebetween.

13. The method of claim 10, wherein:
welding the third wall to the first wall is performed using spot welding to form a joint between the first wall and the third wall; and
the method further comprises applying sealant to seal the joint.

14. The method of claim 8, further comprising affixing a cooling plate to the bottom of the tray on the exterior of the tray.

15. The method of claim 14, wherein affixing the cooling plate to the bottom of the tray occurs before bending the sheet metal blank to form the first wall of the tray, the second wall of the tray, and the bottom of the tray.

16. The method of claim 10, further comprising:
affixing a beam to the third wall of the tray and to the fourth wall of the tray with the beam passing through the interior of the tray;
coupling a first end of the beam to a first structural element of a vehicle; and
coupling a second end of the beam to a second structural element of the vehicle.

17. The method of claim 16, wherein:
the vehicle defines a vehicle longitudinal axis and a vehicle lateral axis;
the first structural element of the vehicle extends generally parallel to the vehicle lateral axis;
the second structural element of the vehicle extends generally parallel to the vehicle lateral axis; and
the beam extends generally parallel to the vehicle longitudinal axis.

18. The method of claim 11, further comprising:
affixing a beam to the third wall of the tray and to the fourth wall of the tray with the beam passing through the interior of the tray;
coupling a first end of the beam to a first structural element of a vehicle; and
coupling a second end of the beam to a second structural element of the vehicle.

19. The method of claim 18, wherein:
the vehicle defines a vehicle longitudinal axis and a vehicle lateral axis;
the first structural element of the vehicle extends generally parallel to the vehicle lateral axis;
the second structural element of the vehicle extends generally parallel to the vehicle lateral axis; and
the beam extends generally parallel to the vehicle longitudinal axis.

20. A vehicle defining a vehicle longitudinal axis and a vehicle lateral axis, the vehicle comprising:
a first vehicle structural element and a second vehicle structural element, the first vehicle structural element and the second vehicle structural element extending generally parallel to the vehicle lateral axis; and
an energy storage system including:
a tray defining an interior of the tray and an exterior of the tray;
a beam passing through the interior of the tray and disposed generally parallel to the vehicle longitudinal axis, the beam coupled at a first end thereof to the first vehicle structural element and the beam coupled at a second end thereof to the second vehicle structural element; and
a plurality of electrical energy storage elements disposed in the tray;
wherein the tray comprises a sheet metal bottom, a first sheet metal side wall integral to and extending generally perpendicularly from the sheet metal bottom, a second sheet metal side wall integral to and extending generally perpendicularly from the sheet metal bottom, a third side wall affixed to the first sheet metal side wall and to the second sheet metal side wall and extending generally perpendicularly from the sheet metal bottom, and a fourth side wall affixed to the first sheet metal side wall and to the second sheet metal side wall and extending generally perpendicularly from the sheet metal bottom.
